(19) United States
(12) Patent Application Publication
(10) Pub. No.: US 2005/0082308 A1
(43) Pub. Date: Apr. 21, 2005

(54) Machine for controlled dispensing of small articles

(76) Inventor: Anton K. Simson, Escondido, CA (US)

Correspondence Address: CHARMASSON & BUCHACA & LEACH LLP, 1545 HOTEL CIRCLE SOUTH, SUITE 150, SAN DIEGO, CA, 92108-3412, US

(21) Appl. No.: 10/967,691

(22) Filed: Oct. 15, 2004

Related U.S. Application Data
(60) Provisional application No. 60/512,608, filed on Oct. 16, 2003.

(51) Int. Cl. G07F 11/12; B65H 3/00; G07F 11/00; B65G 59/00; B65H 1/00

(52) U.S. Cl. 221/105; 221/197; 221/86

(57) ABSTRACT

A vending machine having a substitutable magazine formed to have a number of parallel vertically oriented tubular hoppers for queuing up goods to be dispensed. The magazine is supported on a rotatable platen. A user selects a tube where the desired good is located, rotates the platen so that the tube is in alignment with a dispensing station. Upon payment of the proper fee, the user energizes a solenoid which drives a single item dispensing rocking gate, dropping the item from the selected tube. A dual position pivoting rocker arm gates a single item while preventing subsequent item from falling through.

### PRIOR APPLICATION

This application claims the benefit of U.S. provisional application No. 60/512,608 filed Oct. 16, 2003.

### FIELD OF THE INVENTION

This invention relates to vending machines and more specifically to vending machines utilizing lightweight interchangeable magazines intended for dispensing small lightweight snack items such as individual serving coffee containers.

### BACKGROUND OF THE INVENTION

Conventional vending machines for small snack items must be able to hold a substantial inventory of goods so that they do not need to be serviced too often. Accordingly, they tend to be bulky and heavy and occupy a square meter (10 square feet) of floor space, with a height of almost 2 meters (72 inches). Reloading of such a machine is a time-consuming process involving individually inserting items, checking unsold items for expiration date and inventory purposes, cleaning of the goods-holding station, and collecting and counting cash by servicing employees. These cumbersome procedures are time-consuming, labor intensive, and sometimes give occasion for pilferage and theft.

Conventional machines are not well-adapted to small job sites having 150 employees or less, because the profit generated at such a small site cannot justify the labor cost of servicing the machines. U.S. Pat. No. 6,478,187 Simson et al. fully incorporated herein by this reference offers a solution by providing removable and replaceable magazines for goods which can be loaded more efficiently at a centralized location. However, this machine utilizes sturdy magazines for carrying a wide variety of items such as drink containers and provides a machine which can allow for refrigeration. Many snack items such as individually packaged single serving coffee packets are small, lightweight and contain many different types of coffee. Providing the customer with the ability to select between the many different flavors and types of coffee or tea would be impractical in such machines. Therefore, there is a need for a more simplified, lightweight machine which is inexpensive to manufacture and operate which provides the capacity and selectability to offer many types of uniformly packaged items such as individual serving coffee, but which can be quickly and efficiently serviced by service personnel.

### SUMMARY OF THE INVENTION

The principal and secondary objects of this invention are to provide a vending machine for dispensing a large number of groupings of relatively lightweight, uniformly packaged items such as a single serving coffee packets wherein the machine is both lightweight, rapidly serviceable and inexpensive to manufacture and operate.

These and other objects are achieved by a compact vending machine having a generally cylindrically shaped magazine carrying a plurality of tubular hoppers oriented vertically, each containing a queue of dispensable items. In this way, each tube can contain articles, such as packets of a particular type of coffee, different from articles in the other tubes. For example, one tube can carry French blend while another carries decaffeinated Columbia blend. The magazine is loaded off-site and is of a size which is readily transportable by an individual. The magazine mounts upon a base unit whose upper surface is shaped and dimensioned to receive it. The magazine is detachably supported by a rotatable platen having apertures for each of the hoppers. A user hand-rotates the platen to align the desired hopper tube with the chute of the dispensing station formed into the base unit. Upon receipt of proper funds from either currency, smart card or other funds registration means, the machine is activated allowing the user to push a dispense button. Pushing the button energizes a solenoid which drives a rocking gate mechanism associated with each hopper to discretely and selectively drop the next item in the queue in the selected hopper.

### BRIEF DESCRIPTION OF THE DRAWING

FIG. 1 is a diagrammatic perspective view of a compact machine according to the invention;

FIG. 2 is a cross-sectional view of the magazine portion of the machine of FIG. 1 taken along line 2-2;

FIG. 3 is a top plan view of the base unit of the machine showing the dispensing station oval discharge aperture;

FIG. 4 is a cross-sectional side view of the lower portion of the machine;

FIG. 5 is a diagrammatic cross-sectional side view of the rocking gate mechanism of a single hopper tube in a resting state according to the invention;

FIG. 6 shows the mechanism of FIG. 5 in the active state; and

FIG. 7 shows the mechanism of FIG. 6 returned to a resting state.

### DESCRIPTION OF THE PREFERRED EMBODIMENT OF THE INVENTION

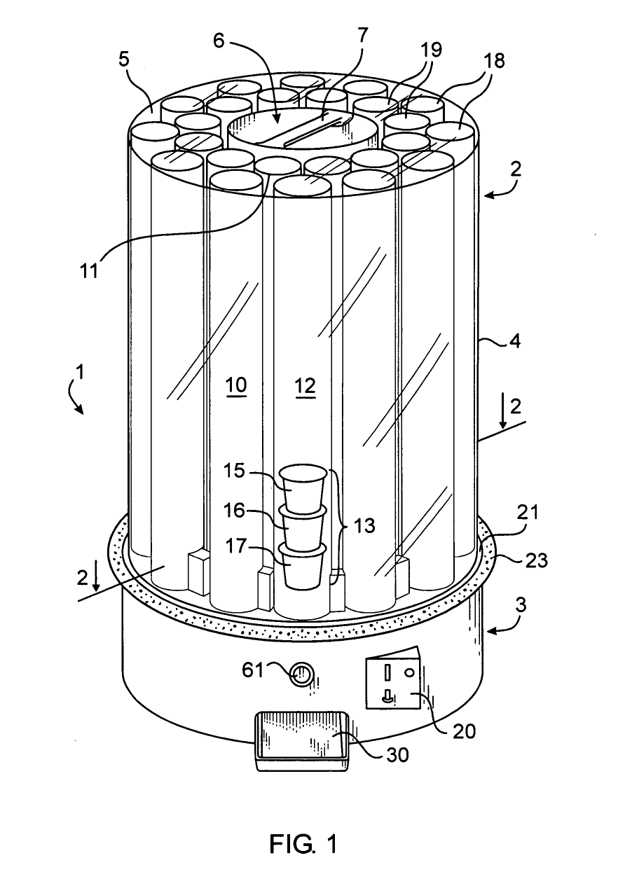

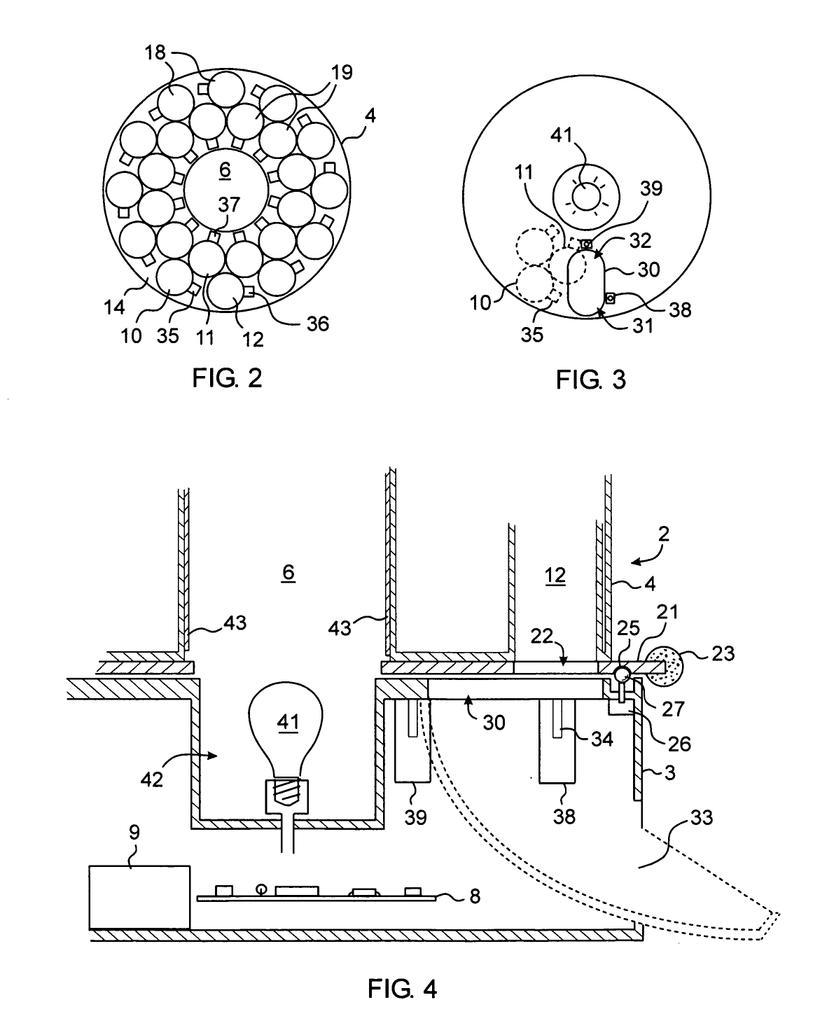

Referring now to the drawing, there is shown in FIGS. 1 through 4, a compact counter-top vending machine 1 having an upper magazine portion 2 and a lower base unit portion 3. The magazine portion has a generally cylindrical outer housing 4 having a disk-shaped top 5 and a central cavity 6 traversed by a handle 7 for both carrying the magazine and to engage or disengage a lock mechanism (not shown) between the magazine and the base portion. The magazine carries a number of vertically oriented cylindrical hopper tubes 10, 11, 12, each carrying a vertical queue 13 of dispensable items 15, 16, 17 such as individual serving coffee containers.

The tubes are arranged in two concentric radial groupings or rings, namely a first outer ring 18 and a second radially inner ring 19. The tubes in each ring are angularly uniformly spaced-apart to form a balanced, axially symmetrical magazine so that in normal operation the weight is distributed substantially evenly upon the base portion.

The magazine lockingly mounts upon the disk-shaped upper surface of a horizontal platen 21 rotatively mounted atop the base portion 3. The platen has a number of apertures 22 aligned with the hopper tubes. A peripheral, circumferential grip 23 runs around the outer edge of the platen, allowing the user to manually rotate the platen.

The base portion 3 also contains mechanisms for individually actuating each of the hopper tubes when rotated into a selected oriention. The base portion houses an electronic dispensing control assembly 8, power supplies 9, and a currency and smart card acceptor 20 or electrical connection to outboard accounting devices or other vending machine so equipped to communicate payment registration to other outboard machines as disclosed in U.S. Pat. No. 6,367,653 Ruskin et al. which patent is fully incorporated herein by this reference. The housing and the hopper tubes are preferably made of durable, rigid, translucent material such as clear plastic to provide a view through the side wall into those hopper tubes containing the desired items. The outer ring of hopper tubes are spaced apart and circumferentially separated by uniformly sized gaps 14. The tubular hoppers of the inner ring are aligned with the gaps to allow viewing of the inner ring tubes. Additionally, an item description placard or stickers may be placed circumferentially around the lower portion of the magazine to indicate the items contained within each tube.

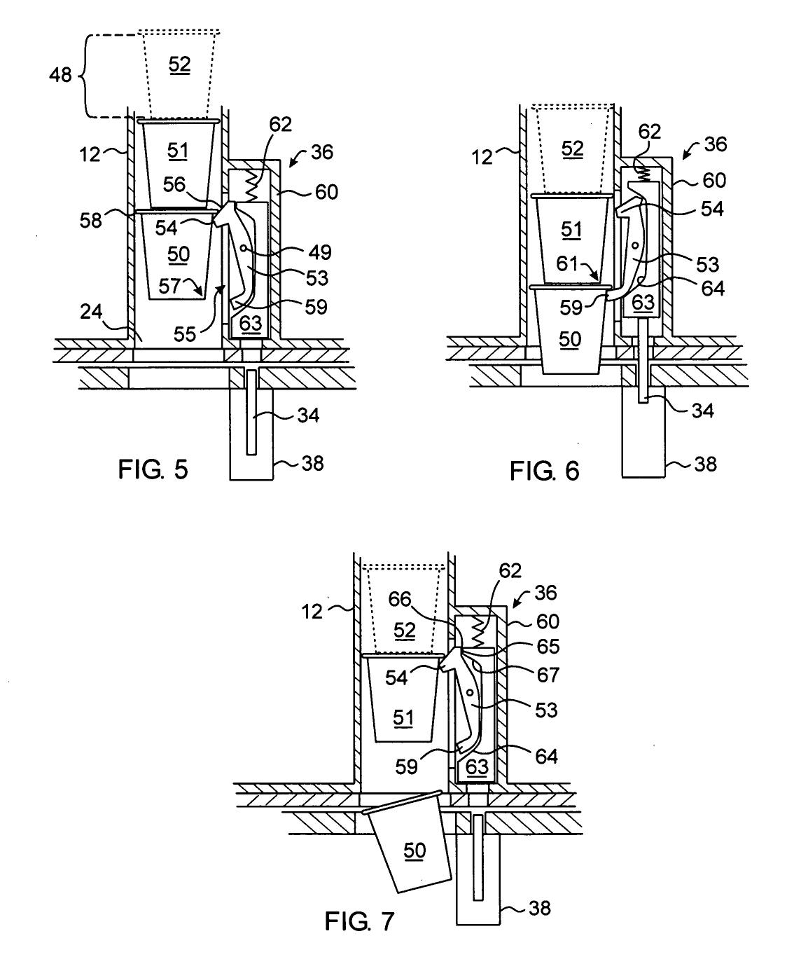

Each of the hopper tubes 10, 11, 12 are accessible for dispensing of items by rotating the platen 21 carrying the magazine 2 so that the appropriate tube is centered over the oval discharge port 30 at the inlet of a dispensing chute 33. Given the angular arrangement of the hopper tubes, only a single tube can be properly aligned at any given position of the platen. The outer ring of the tubes are, of course, aligned on the outer portion 31 of the port and inner ring of the tubes are aligned on the inner portion 32 of the port. In order to assure the correct alignment of the selected hopper tube with the dispensing chute before the article-releasing mechanism is activated, a series of markers in the form of indentations 25 are drilled in a circumferential pattern into a peripheripheral region of the platen under surface. Each indentation is precisely aligned with one of the hopper tubes. A spring biased switch 26 in the base unit has a ball-tipped actuator 27 riding under the series of indentations. The electric signal that triggers the dispensing of the article is run through the switch which closes only when the ball-tipped actuator penetrates one of the indentations, indicating that the magazine and platen are positioned to place the discrete location of one of the hoppers in a correct dispensing position. As specifically illustrated in FIGS. 5-7, each of the outer rings of tubes has a dedicated rocking gate mechanism 35, 36 arranged angularly to the side of each tube proximal to its lower open end 24. When the tube is centered over the corresponding portion of the discharge port, the gate is actuated by the rod 34 of a solenoid 38 positioned just below the rocking gate mechanism of a properly aligned tube. Dissimilarly, and for space saving purposes, each of the inner ring 19 of tubes has a dedicated rocking gate mechanism 37 located radially inwardly from each tube. Thus, when properly oriented over the inner portion of the outlet port, an inner tube is actuated by a solenoid 39 mounted radially inwardly from the innermost edge of the discharge port 30.

Because of the open space left in the central cavity 6 of the magazine, this portion is utilized to provide a lighting display. A high intensity lamp 41 is mounted and energized in a cylindrical well 42 in the center of the base portion 3. The lamp then fills the hollow central cavity 6 of the magazine. The inner side wall of the magazine is formed to have a layer of transmissive right angle film 43 to provide a brighter overall appearance given the intensity of the lamp. Such material is commercially available under the trademark VIKUITI in sheet form from the 3M Company.

FIG. 5 shows the lower portion of a single hopper tube 12 having a queue of items 50,51, 52 for dispensing. A rocking gate mechanism 36 is located to the side of the lower portion of the tube. The gate is shown in its closed, at rest state where a rocker arm 53 pivotably mounted to the gate housing 60 upon a horizontal pivot axel 49 has an upper prong 54 which project horizontally and, in a first position, juts through an aperture 55, preventing the downward movement under gravity of the first item 50 in the queue. The rocker arm has a lower prong 59 projecting in the same direction as the upper prong 54 and vertically spaced apart from the upper prong by a distance substantially equal to the height 48 of the articles. The upper surface 56 of the upper prong is angled downwardly and inwardly from the wall of the tube toward the center of the tube so as to prevent unwanted capturing of the lower edge 57 of an item. Such single serving coffee item containers have a generally slightly conical shape having a base diameter which is smaller than the top diameter and a circumferential flange 58 extending outwardly. The inner diameter of the hopper tube is selected to closely match the larger top diameter of the item while allowing free movement of the container through the tube. The upper prong 54 extends far enough inwardly toward the center axis of the cylindrical hopper tube that it prevents further downward motion of the item. In this state, the lower prong 59 of the arm 53 is recessed within the gate housing 60 and does not penetrate into the tube.

As shown in FIG. 6, the gate mechanism 36, in its actuated state has the upper prong 54 has moved to a second position where it is withdrawn into the housing 60 of the gate mechanic and the lower prong 59 of the rocker arm 53 extends into the cylindrical passageway of the hopper tube 12. This action allows items 51, 52 further up in the queue to drop downwardly due to gravity resting on the top of the bottom item 50. The flange 58 passes over the axial location of the upper prong 54 and becomes stopped in a pre-dispensed position by the lower prong 59. The subsequent item 51 is allowed to drop further down and is stopped by the top of the lower item 50. However, its base portion 61 has also passed by the upper prong 54 axial location. The rocker arm 53 is supported and activated by a bolt 63 having a cam surface 64 acting against the back of the rocker arm and patterned to alternately thrust the upper then lower prongs into penetration of the hopper tube as the bolt is translated between lower and upper vertical positions by the solenoid 38. The cam bolt 63 is resiliently biased toward the lower position by a spring 62.

As shown in FIG. 7, when the solenoid 38 becomes de-energized, the spring 62 forces the bolt 63 downward towards its original resting position, thereby causing the upper prong 54 of the arm 53 to be forced out into the cylindrical channel of the hopper 12 and the lower prong 59 to rock back into its recessed position within the gate housing 60. At this point, the retracted lower prong 59 then allows the lowest item 50 to freely fall through, out of the hopper tube and on to be dispensed. The upper prong 54 now having moved fully back into its resting position, engages and prevents passage of the upper lip of the subsequent item 51.

The cam surface 64 of the actuating bolt 63 is uniquely shaped for driving the lower prong 59 of the rocker arm outward during actuation. Further, the upper portion of the bolt has a vertically flattened surface 65 for providing a bearing surface against a corresponding vertically flattened top portion outward surface 66 of the rocker arm. This provides a lock position to the rocker arm in the rest state. In this way, forces radially outward from the central axis of the tube onto the rocker arm which would seek to cause the rocker arm upper prong to recess are prevented from doing so. This allows for the greater ruggedness of the cartridge magazine during transport so that unwanted dispensing of the lower items is prevented. The bolt 63 also has a tapered cam surface 67 on its upper portion which causes or forces the upper prong 54 out into the resting position during downward motion of the bolt.

The article dispensing control assembly 8 includes a microprocessor programmed to control the operation of the currency and smart card acceptor 20 and the generation of the signal allowing the user ofthe machine to trigger the release of the selected article by pushing a button 61 at the front of the base unit 3.

According to the teaching of the afore-mentioned patent, smart cards can be used to pay for the purchase, program the price and location of the dispensable goods, and down-low sales records. The computer program also allows the amount of currency deposited in the currency acceptor 20 to be entirely credited to the user smart card from which current and later purchases can be debited. The system has also the capability of controlling the dispensing of article from a gang of vending devices including snack and beverages machines as well as additional beverage concentrate packet dispensing machines.

Because of the stiffness afforded to the design by the spaced-apart hopper tubes, the magazine can be made very inexpensively and lightly using commercially available plastic thin wall tubing for the hoppers having a wall thickness of approximately 0.5 millimeters (0.2 inch). Such tubing is commercially available from ClearTec Packaging of St. Louis, Mo.

Those skilled in the art will readily appreciate that some or all of the tubes can be resized and the dimensions of the rocking gate adjusted to accommodate a queue of uniformly differently sized and shaped items.

Those skilled in the art will readily appreciate the simplified nature of the drawing for the purposes of functional clarity. Many minor modifications are available to provide for reduction in materials and to provide standard tamper-resistant features.

While the preferred embodiments of the invention have been described, modifications can be made and other embodiments may be devised without departing from the spirit of the invention and the scope of the appended claims.

1. A machine for selectively dispensing each of a plurality of articles, which comprises:
a magazine grouping a plurality of vertical, elongated hopper tubes, each of said tubes having an open lower end and being shaped and dimensioned to hold a set of said articles having a common given height;
a mechanism associated with each of said hoppers positioned proximally to said lower end for discretely dispensing one of said articles in said hopper;
a base including a top surface shaped and dimensioned to receive said magazine, a dispensing chute having an inlet in said top surface, and a dispensing control assembly driving said mechanism; and
a means for detachably and rotatively mounting said magazine on said top surface.

2. The machine of claim 1 wherein said means for mounting comprises a horizontal platen rotatively secured to said top surface, said platen having a plurality of apertures each positioned to align with one of said open ends.

3. The machine of claim 2 wherein said platen further comprises a peripheral grip.

4. The machine of claim 2 wherein said mechanism comprises the rocker arm mounted on a horizontal axle, said arm including upper and lower horizontally projecting prongs shaped and positioned to alternately, in a first position, penetrate into, and, in a second position, withdraw from a lower portion of one of said hoppers;
wherein said prongs when in said first position interfere with the dispensing of one of said articles.

5. The machine of claim 4 wherein said upper and lower prongs are spaced apart by a distance substantially equal to said height.

6. The machine of claim 1 wherein said hoppers are arranged along concentric outer and inner rings;
wherein the hoppers in the outer ring are circumferentially separated by uniformly sized gaps, and each hopper in the inner ring is aligned with one of said gaps;
whereby the hoppers in both of said rings have lower portions at discrete circumferential positions.

7. The machine of claim 5 wherein said mechanism further comprises:
a cam bolt having a patterned surface in contact with said rocker arm;
said cam bolt being vertically translatable from a first lower position wherein said lower prong is forced into the hopper to a higher position wherein said upper prong is forced into said hopper;
said cam bolt being resiliently biased toward said lower position;
a rod vertically projecting from said base into contact with said cam bolt; and
means for temporarily raising said rod to activate said cam and rocker arm.

8. The machine of claim 7 wherein said means for raising comprises a solenoid.

9. The machine of claim 6 which further comprises means for detecting the alignment of one of said hoppers with said inlet.

10. The device of claim 9 wherein said means for detecting comprises a switch having an actuator shaped and positioned to respond to a series of markers positioned in a circumferential pattern in a lower surface region of said platen.

11. A dispenser for successively dispensing each of a plurality of substantially uniformly shaped and sized articles, said dispenser comprises:
a guide arranging said articles in a queue;
a gate positioned at one end of said guide;
wherein said gate comprises:
a frame;
a rocker arm pivotably mounted to said frame, said rocker arm having first and second prongs;
a bolt slidingly mounted to said frame, said bolt being biased toward a first closed position;
said bolt comprising:
a cam surface for contacting said rocker arm thereby forcing said rocker arm into a second open position retracting said first prong and extending said second prong; and
means for releasably sliding said bolt from said closed position to an open position.

12. The dispenser of claim 11, wherein said dispenser further comprises a second guide and gate substantially similar to said first guide and gate formed into a carousel magazine, wherein said magazine is disengageable from a dispensing base unit.

13. The dispenser of claim 12, wherein said base unit comprises a rotatable top platen for carrying said magazine.
